(19) United States
(12) Patent Application Publication
(10) Pub. No.: US 2016/0366896 A1
(43) Pub. Date: Dec. 22, 2016

(54) Food Product with Reduced RAG:SAG Ratio

(71) Applicant: Frito-Lay North America, Inc., Plano, TX (US)

(72) Inventors: YiFang CHU, Glenview, IL (US); Jodee JOHNSON, Lake in the Hills, IL (US); Kimberly KRENEK, Addison, TX (US); Mark NISBET, Dallas, TX (US); Yang PAN, Lewisville, TX (US)

(21) Appl. No.: 15/184,609

(22) Filed: Jun. 16, 2016

Related U.S. Application Data
(60) Provisional application No. 62/350,519, filed on Jun. 15, 2016.
(60) Provisional application No. 62/182,179, filed on Jun. 19, 2015.

(51) Int. Cl. A21D 10/00; A21D 2/18

(52) U.S. Cl. CPC A21D 10/002; A21D 2/181; A21D 2/186; A21D 2/183

(57) ABSTRACT

A dough, dough-based snack, and method of manufacture is disclosed herein. The dough includes a source of slowly available glucose, a viscosity-building ingredient coated with oil, a starch gelatinization inhibitor, and a binding agent that bonds the source of slowly available glucose, the viscosity-building ingredient, and the starch gelatinization inhibitor to form the dough. The dough comprises a moisture content of between 10-23%, and can be used to create a dough-based food product having a moisture content of between about 2.0-4.0% and a RAG:SAG ratio of less than 4.2.

### CROSS-REFERENCE TO RELATED APPLICATIONS

This application is a Nonprovisional of U.S. Provisional Patent Application Ser. No. 62/350,519, filed Jun. 15, 2016, and U.S. Provisional Patent Application Ser. No. 62/182,179, filed Jun. 19, 2015, which are incorporated by reference in their entirety.

### BACKGROUND OF THE INVENTION

Technical Field

The present invention relates generally to a dough-based food product. More particularly, the disclosure herein provides for a crunchy food product having a particular RAG:SAG ratio that is correlated with an improved glycemic response.

Background

Dietary carbohydrates are digested and absorbed at different rates upon consumption. Carbohydrates that are quickly absorbed are referred to as rapidly available glucose (RAG), and carbohydrates that are slowly absorbed are referred to as slowly available glucose (SAG). Existing literature has described at least one method by which to determine the SAG and RAG content of foods—the Englyst method—in which a food sample is coarsely ground to simulate mastication and subjected to a manufactured enzymatic digestion process under standardized conditions to mimic traditional digestion. Glucose available at 20 minutes of simulated digestion is identified as RAG. At 120 minutes, available glucose is measured, then the RAG levels at 20 minutes are subtracted. The remainder is the SAG concentration that is available between 20 and 120 minutes. Thus, the Englyst method identifies RAG and SAG components by a time at which they become bioavailable. Accordingly, consumption of carbohydrate-based foods results in a glycemic response that is characterized by a first, narrow and relatively tall spike in the glucose response curve attributable to the presence of RAG. The glycemic response also includes a second, broader and steadier response attributable to the presence of SAG.

### SUMMARY OF THE INVENTION

Consumer preferences dictate much of the innovation for food-based products. For example, some consumers have shown a preference for crunchy, savory food products, such as snacks that can be eaten on the go. Another emerging trend is a preference for healthier food products, particularly those that purport to provide slow release energy. Existing scientific literature suggests that slow release energy provides a desired postprandial glycemic response and improves satiety between meals. Therefore, novel aspects of the disclosure are directed to a crunchy, savory food product that includes a particular range of RAG:SAG ratios that has been shown to provide slow release energy. In other embodiments, the food product may be sweet, or a combination of sweet and savory.

Accordingly, inventors describe herein a dough, dough-based food product, and corresponding method of manufacture. More particularly, the dough is formed from specially selected ingredients, processed according to a novel method, and cooked into a dough-based food product having a final moisture content between about 2.0-20%, or more particularly between 2-10%, and even more particularly between 2-4%; and a RAG:SAG ratio in some embodiments which falls between 1.5-4.2, and more particularly between 1.9-3.8. The ingredients and processing steps provide for different modes of action that achieve a positive glycemic response, which literature correlates with healthier physiological responses, such as tempered blood glucose absorption and a reduction of certain chronic diseases, such as diabetes. In addition, clinical trials have shown desirable in vivo results.

For clarification, when the term “percent” is used in conjunction with an amount of an ingredient, such as a moisture content of 2.0-20 percent or 2.0-20%, the term shall refer to a weight percent unless otherwise noted.

In a first embodiment, a dough is provided for creating a food product having a RAG:SAG ratio between about 1.5-4.2, and more particularly between 1.9-3.8. The dough includes a source of rapidly available glucose (RAG) and slowly available glucose (SAG), a viscosity-building ingredient coated with oil, a starch gelatinization inhibitor, and a binding agent. The binding agent bonds the ingredients to form a food matrix, and includes an optional amount of added water if necessary to raise the moisture content of the dough to a range between 5-27% and more particularly between 10-23%. As used herein, the moisture content of the dough may also referred to in the alternative as an “intermediate moisture content” when discussed relative to the dough-based food product formed from the dough.

In a second embodiment, a dough-based food product is provided having a RAG:SAG ratio between about 1.5-4.2, and more particularly between 1.9-3.8, and a final moisture content between 2.0-20 percent. The food product is formed from a source of rapidly available glucose (RAG) and slowly available glucose (SAG), a viscosity-building ingredient coated with oil, a starch gelatinization inhibitor, and a binding agent that binds the ingredients together to form a food matrix. In a first aspect, the dough-based food product is a cracker with a RAG:SAG ratio between 3.6 and 4.2, and more particularly of about 3.8 and a final moisture content between 3.0-4.0%, and more particularly of about 3.5%. In a second aspect, the dough-based food product is a cluster with a RAG:SAG ratio between 2.6-3.8, and more particularly of about 2.8 and a final moisture content between 2.0-3.0%, and more particularly of about 2.45%.

In a third embodiment, a method is provided for creating a dough-based food product having a RAG:SAG ratio of between 1.5-4.2, and more particularly between 1.9-3.8, and a final moisture content of approximately 2.0-20%, and more particularly between 2.0-4.0% in some embodiments. The method includes the steps of combining dry ingredients to form a dry mix, then adding oil to the dry mix to form a cold roux. A cold roux is an intermediate product formed from a mixture of dry ingredients and oil, in the absence of added water, before the product achieves a dough-like consistency. Afterwards, a binder slurry is mixed into the cold roux to form a dough that comprises a moisture content between approximately 5-27% but more particularly between 10-23%. In one embodiment, if the dry mix lacks a viscosity-building ingredient coated with oil, an oil-coated viscosity-building ingredient is mixed into the dough. In an optional step, the dough may be formed into one of a number of different forms, such as a cracker or cluster and then cooked to form the dough-based food product.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a graph comparing the effect of certain ingredients and processing steps on a percent glucose expression and RAG:SAG ratios.

FIG. 2 is a three-dimensional graph depicting the effect of two variables, temperature and moisture content, on the effect of RAG:SAG ratio.

FIG. 3 is two-dimensional graph showing RAG:SAG ratio as a function of moisture content of dough vs. cooking temperature.

FIG. 4 is a flowchart of a high-level process for producing a dough-based food product in accordance with an illustrative embodiment.

FIG. 5 is a graph depicting in vivo blood glucose and serum insulin responses for the cracker trial.

FIG. 6 is a graph depicting in vivo blood glucose and serum insulin responses for the cluster trial.

### DETAILED DESCRIPTION

In the past, it was believed that the desired postprandial glycemic response was attributable to either an amount of RAG or in the alternative an amount of SAG. However, recent literature suggests that the glycemic response of food is more closely and significantly attributable to a ratio of RAG:SAG in the food rather than a RAG concentration or SAG concentration individually. (Araya et al, 2002). In particular, studies have shown that the RAG:SAG ratio of common meals has a proportionate relationship with a glycemic index of those meals, whereas the RAG content and the GI of the meal lacked a meaningful relationship. (Id). Restated, low GI meals correlated with a low RAG:SAG ratio and higher GI meals correlated with a higher RAG:SAG ratio.

The glycemic index (GI) has been created in an attempt to categorize the glycemic response of foods. In particular, the glycemic index is a number associated with a particular food that describes the food's effect on a consumer's blood glucose level upon consumption. A common GI range is between 50 and 100, where 100 is typically assigned to pure glucose. A high GI food is often associated with large amounts of RAG, whereas a low GI food is associated with a larger amount of SAG.

Thus, inventors sought to confirm that the creation of a dough-based food product with an engineered RAG:SAG ratio that would correlate with desirable in vivo results. To this end, inventors have devised a dough, a dough-based food product, and a method of creating the dough-based food product with a RAG:SAG ratio that, in some embodiments, fall in the range of 1.5-4.2, and more particularly between 1.9-3.8. This particular range of was believed to provide an improved glycemic response.

The glycemic response of a consumed food is based upon the sum total of all factors that affect the influx and removal of glucose in circulation. Accordingly, inventors have proposed a synergistic combination of different modes of action to create a dough-based food product that has a RAG:SAG ratio that is believed to correspond with a positive glycemic response. The positive glycemic response is manifested in terms of a decreased rate of glucose absorption, which is attributable to the selection and use of raw starch ingredients with relatively high concentration of SAG (including whole grain flour and high amylose starch); ingredients and processing parameters that limit starch gelatinization (low dough moisture, temperature cycling baking techniques, and starch gelatinization inhibitors such as lactose); viscosity building ingredients that slow gastric emptying (which include beta glucan and guar gum), soluble fiber that slows glucose absorption in the intestine, enhanced food matrix structures that decrease enzyme accessibility, and whole grains with polyphenols to decrease amylase activity. Thus, inventors are proposing to develop a dough and a dough-based food product with a RAG:SAG ratio within a selected range by manipulating one or more factors including enzyme accessibility, the rate of hydrolysis, digestion rate, and food motility.

In addition to the general discussion of RAG and SAG set forth above, it is helpful to understand that RAG is a defined entity of starch with subtypes 1-4. (Zhang et al, 2013). In contrast, SAG is less well-defined in that there are no definitive subtypes, and its existence is qualified based upon a manifestation of increased glucose concentration between 20-120 minutes after enzyme digestion. Thus, an ingredient that is described as having an amount of SAG is understood as having an amount of absorbable carbohydrate manifested at a time between 20-120 minutes. That being said, using an ingredient with a higher amount of SAG can be used to increase SAG in blood glucose. Likewise, decreasing the rate at which a carbohydrate is digested is another mechanism to increase the SAG concentration. As a simple example, consumption of pure glucose will typically be manifested as RAG (with a rise in blood glucose levels at 20 minutes of consumption) and result in the rapid blood glucose spike. However, if the pure glucose was encapsulated in a coating that took 60 minutes to dissolve or become digested, then that pure glucose would be expressed as SAG sometime between 20-120 minutes.

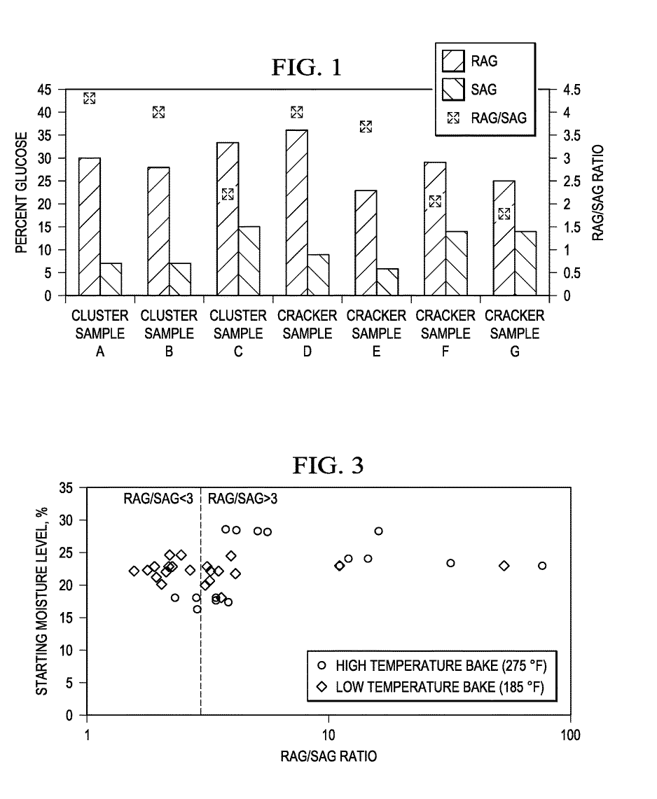

One mechanism proposed by inventors to increase the relative SAG concentration is by including viscosity-building ingredients that reduce the rate of digestion. Slowed digestion results in a slower conversion and release of glucose, which is later expressed as SAG instead of RAG. Increased viscosity decreases digestion rate in two ways. First, it decreases the mobility of digestive enzymes that break down carbohydrates. Second, it reduces the rate of mechanical breakdown of the food in the gut. Various types of ingredients may be used by as viscosity-building ingredients, including oat flakes and barley flakes, or any grain with soluble fiber, or any starch gum or hydrocolloid that imparts viscosity. Oat flakes can serve as a viscosity-building ingredient due to the presence of beta glucan. Weightain® and Sustagrain®, which are described in more detail below, may also be used as viscosity-building ingredients. To test the relative effect of certain viscosity-building ingredients on RAG:SAG ratio, as well as the effect of moisture and heat, inventors devised a series of experiments varying ingredients and processing variables. The results of those experiments are provided in FIG. 1 below.

FIG. 1 is a chart comparing various samples of snack products, illustrating the general effect of ingredients and processing conditions on RAG and SAG. On the left axis of the graph are gradations reflecting a percent glucose for the RAG and SAG components of the snack product, as identified in the accompanying legend. The right axis are displays gradations that correspond to RAG:SAG ratios depicts on the chart and identified by the icon in the accompanying legend. Further, samples A-C are cluster samples whereas samples D-G are cracker samples.

Cluster sample A is a control cluster. Cluster sample B is altered to include Weightain®, and cluster sample C is a cluster having ingredients presented in Table 19, below. Further, each of the cluster samples A-C are processed similarly. Added Weightain® appeared to decrease a concentration of RAG, but had no discernable effect on SAG levels. As a result, a slight decrease in RAG:SAG ratio was observed. In particular, the RAG:SAG ratio is approximately 4.4 and 4 for the cluster sample A and sample B, respectively. A comparison of cluster samples A-C show that ingredient selection can have a positive reduction in RAG:SAG ratio.

Samples D-F are cracker samples that illustrate relative RAG and SAG concentrations along with corresponding RAG:SAG ratios for varied formulations and processing conditions. Cracker sample D is formed from a dough having a high moisture content that is processed at high heat. Cracker sample E is formed from a dough that also includes a high moisture content, but includes the added ingredient of Weightain®, a viscosity-building ingredient, and is processed at high heat. Cracker sample F is formed from a dough having a low moisture content and is processed at low heat. Finally, cracker sample G is formed from a dough having a low moisture content and added Weightain®, which is processed at low heat.

Comparing the results of cracker samples D-F show some trends that inventors took into consideration in formulating a dough and a corresponding dough-based cracker. High moisture and high heat resulted in a relatively higher RAG:SAG ratio, regardless of the addition of Weightain®. However, the Weightain® ingredient did produce a decreased RAG content. Without being bound by this theory, inventors believe that the Weightain® ingredient slows the enzymatic activity that results in the breakdown of carbohydrates that yield RAG.

Comparing cracker samples F and G, low moisture and low heat result in an overall lower concentration of RAG and higher concentration of SAG. The resultant RAG:SAG ratio is approximately 2 for cracker sample F and about 1.8 for cracker sample G. The slight difference in RAG:SAG ratio can likely be attributable, to some extent, to the presence of Weightain®, which decreased the concentration of RAG, as was seen in the comparison of cracker sample E with cracker sample D.

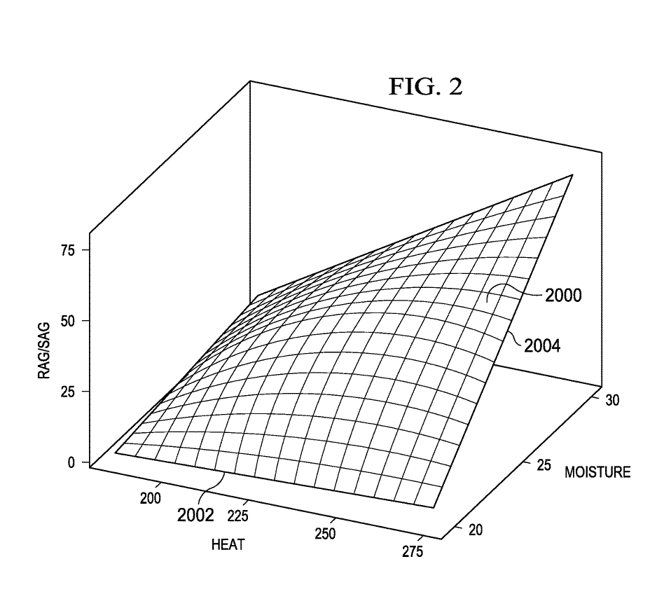

Thus, the results of cracker samples D-G, show that RAG:SAG ratios are less variable in the presence of Weightain®. The combination of low moisture and low heat produced the desired RAG:SAG ratio, whereas the high moisture and high heat yielded RAG:SAG ratios exceeding 2.7. To illustrate the effect of heat versus moisture on the RAG:SAG ratio, inventors plotted the effect of increasing temperatures and increasing temperature versus RAG:SAG and provided the results in curve 2002 of FIG. 2.

FIG. 2 is a three-dimensional graph depicting the effect of temperature and moisture of a dough with respect to the RAG:SAG ratio. Curve 2002 depicts the effect of changing moisture and heat with a constant dough formulation. The three-dimensional graph depicts RAG:SAG ratio on an x-axis, heat along a y-axis, and moisture on a z-axis. Temperature was varied between 175 degrees Fahrenheit and 275 degrees Fahrenheit, and moisture was varied between 20 percent by weight and 30 percent by weight. The graph depicts a smaller effect on RAG:SAG ratio with a temperature increase of 100 degree Fahrenheit, as can be seen by edge 2002 on curve 2000, particularly when compared to dough moisture content. For example, a ten percent increase in moisture content increased the RAG:SAG ratio by approximately 75, which is evident from edge 2004 on curve 2000.

The data provided in FIGS. 1 and 2 summarizes results obtained by experimenting with ingredient selection, moisture content level of a dough, and heat treatment to create food product products with desirable properties, such as a RAG:SAG ratio that correlates with a positive Englyst result but provides a desirable texture. Further detail regarding ingredient selection, dough moisture content, and processing steps, such as heat treatment, are provided below.

Ingredient Selection

Inventors proposed the incorporation of raw starch ingredients into the dough-based food product because these ingredients have a relatively high amount of SAG as compared with processed starch ingredients. The native amount of SAG was believed to provide a desirable RAG:SAG ratio. To test this theory, sample snacks were created using varying starch products, and RAG:SAG ratio was measured. In particular, inventors considered the effect of Amylogel® 03003, XPandR, and UltraCrisp® on a resultant RAG:SAG ratio. The results for snacks created with the different starches are provided in Table 1 below, which shows that Amylogel® 03003 provided higher SAG values than XPandR™.

Amylogel® 03003 is a native high amylose corn starch that contains greater than 70% amylose that has a helical structure. The structure is believed to render it less accessible to digestive enzymes. Further, it forms small granules characterized by delayed granule swelling/hydration and higher gelatinization temperatures. As a result, Amylogel® 03003 manifests as SAG rather than RAG. XPandR™ is a pre-gelatinized waxy maize starch, and Ultra-Crisp® is a cold water swelling, unmodified waxy maize starch.

TABLE 1
Effect of Various Starches on RAG:SAG ratio.

| | | | RAG:SAG |
|---|---|---|---|
| Ingredients | RAG | SAG | Ratio |
| 14% oats, 8% Amylogel, 18% Promitor | 29% | 14% | 2.04 |
| 14% oats, 8% XPandR, 18% Promitor | 36% | 12% | 3.08 |
| 10% oats, 10% Weightain, 8% Amylogel, 10% | 25% | 14% | 1.78 |
| Promitor | | | |
| 10% oats, 10% Weightain, 8% XPandR, 10% | 33% | 12% | 2.68 |
| Promitor | | | |
| 9% oats, 8% starch blend (with 4% UltraCrisp), | 33% | 15% | 2.13 |
| 14% Promitor | | | |

As can be seen from Table 1, snacks created with Amylogel® yielded lower RAG:SAG ratios regardless of the presence of a viscosity-building ingredient, such as Weightain®. The effect of Ultra-Crisp® was unascertainable given that it was only available as a starch blend.

Starch-based ingredients affect RAG:SAG ratio through a process called starch gelatinization, which is the process of breaking down starch molecules in the presence of water and heat. Exposure of moist dough to heat causes swelling in the starch granules and eventually causes the granules to burst, releasing polysaccharides. Starch gelatinization increases digestibility of the carbohydrate, and promotes the absorption of carbohydrates which is manifested as RAG. Retarding the starch gelatinization process results in a slower absorption of glucose.

To protect against starch gelatinization by increasing the gelatinization temperature, inventors proposed incorporating into the dough a starch gelatinization inhibitor that comprises between 10-25% a batch weight of the dough. Disaccharides, such as sucrose or lactose can serve as starch gelatinization inhibitors. In other embodiments, the starch gelatinization inhibitor can take the form of any mono- or disaccharide, which have lower molecular weights than other forms of saccharides, such as trisaccharides, oligosaccharides, and polysaccharides. It is believed that these lower molecular weight mono- and/or disaccharide ingredients protect against starch gelatinization by reducing the water activity of the dough. Because sucrose has a sweeter taste profile than lactose, the latter may be used as a starch gelatinization inhibitor for the creation of savory snacks without increased sweetness. The gelatinization inhibitor allows the snack food product to be baked at a higher temperature, which improves texture.

To confirm that effect of lactose on RAG:SAG ratio, the amount of lactose was varied with varying moisture content and heat treatment steps and the resultant RAG:SAG ratio was measured. The results, which are shown in Table 2, indicate that higher lactose levels had a more protective effect against starch gelatinization, which was manifested as a lower RAG:SAG ratio. However, because the Englyst procedure only utilized pepsin, amylase, pacreatin, and invertase but not lactase, lactose could not be detected as part of RAG of SAG. Notwithstanding, the protective effect of lactose could still be observed despite the fact that the actual RAG:SAG ratios were unobtainable in the present Englyst procedure.

TABLE 2
Starch Gelatinization Inhibitor and RAG:SAG Ratio.

| | | | RAG:SAG |
|---|---|---|---|
| Variables | RAG | SAG | Ratio |
| 17% lactose, low heat (185° F./85° C.), | 25% | 16% | 1.57 |
| 19% dough moisture | | | |
| 8.25% lactose, low heat (185° F./85° C.), | 33% | 3% | 11.06 |
| 27% dough moisture | | | |
| 17% lactose, high heat (275° F./135° C.), | 34% | 3% | 11.06 |
| 27% dough moisture | | | |
| 8.25% lactose, high heat | 43% | 0.58% | 76.15 |
| (275° F./135° C.), 27% dough moisture | | | |

In one embodiment, increasing the amount of all-purpose flour in the presence of lactose resulted in a desirable decrease of RAG:SAG ratio, as can be seen in Tables 3 and 4, below.

TABLE 3
Sample with Lactose and 27% AP Flour.

| Ingredient | Weight % |
|---|---|
| Baby oats | 13.2% |
| Sustagrain ® flakes | 7.00% |
| Sustagrain ® flour | 3.00% |
| NAT FL (Molten Butter | 0.08% |
| Type) | |
| Baking Powder | 0.80% |
| White AP Flour | 27.00% |
| Lactose | 17.00% |
| Promitor 85L | 15.0% |
| Salt | 0.5% |
| Oil | 7.9% |
| DATEM | 0.5% |
| Water | 8.0% |

TABLE 4
Sample with Lactose and 30% AP Flour.

| Ingredient | Weight % |
|---|---|
| Baby oats | 13.2% |
| Sustagrain ® flakes | 7.00% |
| NAT FL (Molten Butter | 0.08% |
| Type) | |
| Baking Powder | 0.80% |
| White AP Flour | 27.00% |
| Lactose | 17.00% |
| Promitor 85L | 15.0% |
| Salt | 0.5% |
| Oil | 7.9% |
| DATEM | 0.5% |
| Water | 8.0% |

The 3% Sustagrain® flour in the sample of Table 4 was replaced in Table 5 with 3% AP Flour. Both samples were baked at 275° F. and the resulting RAG:SAG ratios are provided in Table 5. As can be seen, increased amounts of AP flour in the presence of a starch gelatinization inhibitor resulted in a decreased RAG:SAG ratio. The AP flour, which is a source of RAG and SAG, comprises between 5-35% of the batch weight of the dough.

TABLE 5
RAG:SAG Comparison for Increased AP Flour Content.

| Sample | RAG | SAG | RAG:SAG Ratio |
|---|---|---|---|
| Lactose Sample with 27% AP Flour | 32% | 9% | 3.42 |
| Lactose Sample with 30% AP Flour | 31% | 11% | 2.84 |

In another example, lactose was replaced with sucrose and results indicated a further decreased RAG:SAG ratio. The final snack product had a harder texture that was crunchier and had more spread, but with less lift. The tables below show a first sample that incorporated lactose and a second sample that replaced the lactose with sucrose. A comparison of the resultant RAG:SAG ratio is also provided and shown in Table 8.

TABLE 6
Sample with Lactose.

| Ingredient | Weight % |
|---|---|
| Baby oats | 12.00% |
| Sustagrain ® flakes | 3.00% |
| Sustagrain ® flour | 7.20% |
| Baking Powder | 0.80% |
| White AP flour | 23.25% |
| Lactose | 8.25% |
| Weightain ® | 10.00% |
| Promitor 85L | 8.8% |
| Salt | 0.5% |
| Oil | 10.0% |
| DATEM | 0.5% |
| Water | 15.8% |

TABLE 7
Sample with Sucrose replacing Lactose.

| Ingredient | Weight % |
|---|---|
| Baby oats | 12.00% |
| Sustagrain ® flakes | 3.00% |
| Sustagrain ® flour | 7.20% |
| Baking Powder | 0.80% |
| White AP flour | 23.25% |
| Lactose | 8.25% |
| Weightain ® | 10.00% |
| Promitor 85L | 8.8% |
| Salt | 0.5% |
| Oil | 10.0% |
| DATEM | 0.5% |
| Water | 15.8% |

TABLE 8
RAG:SAG Comparison for Lactose Sample and Sucrose Sample.

| Sample | RAG | SAG | RAG:SAG Ratio |
|---|---|---|---|
| Lactose Sample | 32% | 9% | 3.42 |
| Sucrose Sample | 39% | 14% | 2.86 |

As previously mentioned, incorporation of viscosity-building ingredients into doughs is believed to reduce the rate of digestion. Inventors theorize that the increased viscosity contributes to a positive Englyst result by slowing down enzyme mobility, which in turn slows the rate at which carbohydrates in food can be broken down and absorbed. Effectively, the glucose is manifested later as SAG instead of RAG. Examples of viscosity-building ingredients include Weightain®, Sustagrain®, barley flakes, and oat flakes. Weightain® is a satiety-inducing ingredient provided by Ingredion®, which has a RAG content of about 6%, a SAG content of about 9%, and a RAG:SAG ratio of 0.67. Weightain® is a non-digestible dietary fiber consisting of about 80 percent whole grain corn flour and about 20 percent guar gum by weight. Guar gum is a common ingredient often used as a thickener, which can increase a viscosity of food products to which it is added. While the whole grain component of the Weightain® ingredient induced desirable fragility of the final food product, the guar gum component was responsible for increasing the perceived gumminess of the finished food product due to the increased uptake of water by the guar gum component. Inventors were able to reduce the perceived gumminess of the Weightain® by coating the ingredient with oil before introduction of water. Inventors discovered that by coating the viscosity-building ingredient with oil before introduction of the viscosity-building ingredient with water had an unexpected effect on the reduction of RAG:SAG ratio.

Sustagrain® is a proprietary ingredient offered by ConAgra Mills and is formulated from barley flakes and beta glucan, which is a polysaccharide that contains glucose as a structural component.

In comparable formulations, Weightain® has been shown to decrease RAG, which has a corresponding effect of decreasing the RAG:SAG ratio. For example, the two tables below show cracker formulations, the first without Weightain® and the second with Weightain®. Each of the samples was baked at a temperature of 185° F. (85° C.).

TABLE 9
Cracker Sample without Weightain ®.

| Ingredient: Sample 1 | Weight % |
|---|---|
| Baby oats | 13.49 |
| NAT FL (Molten | 0.08 |
| Butter Type) | |
| Amylogel 03003 | 8.05 |
| UltraGrain | 37.79 |
| Promitor 85L | 18 |
| Salt | 0.80 |
| Oil | 11.5 |
| Mono and Di | 0.20 |
| Glycerides | |
| Water | 10.10 |

TABLE 10
Cracker Sample with Weightain ®

| Ingredient: Sample 2 | Weight % |
|---|---|
| Baby oats | 10 |
| NAT FL (Molten | 0.08 |
| Butter Type) | |
| Amylogel 03003 | 8.05 |
| UltraGrain | 35.33 |
| Weightain | 10 |
| Promitor 85L | 10 |
| Salt | 0.80 |
| Oil | 11.5 |
| Mono and Di | 0.20 |
| Glycerides | |
| Water | 14.10 |

The RAG and SAG amounts for samples described in Tables 9 and 10 are shown in Table 11, below. As can be seen, the cracker sample with Weightain® has a lower RAG:SAG ratio than the cracker sample lacking Weightain®.

TABLE 11
Effect of Weightain ® on RAG:SAG Ratio.

| Sample | RAG | SAG | RAG:SAG Ratio |
|---|---|---|---|
| Cracker without Weightain ® | 29% | 14% | 2.04 |
| Cracker with Weightain ® | 25% | 14% | 1.78 |

In another experiment, Weightain® was added to a sample formulation and other dry phase ingredients were lowered proportionally, as shown in Tables 12 and 13. The results showed a decrease in RAG, and a slight decrease in RAG:SAG ratio, as can be seen in Table 14. Further, each sample was cooked by cycling the temperature from 275° F. for five minutes, then to 185° F. for 90 minutes, then at 275° F. for 30 minutes.

TABLE 12
Sample Formulation without Weightain ®.

| Ingredient | Weight % |
|---|---|
| Baby oats | 14.55% |
| Sustagrain ® flakes | 4.00% |
| Sustagrain ® flour | 9.20% |
| Baking Powder | 0.80% |
| White AP flour | 27.70% |
| Lactose | 8.25% |
| Promitor 85L | 8.8% |
| Salt | 0.5% |
| Oil | 10.0% |
| DATEM | 0.5% |
| Water | 15.8% |

TABLE 13
Sample formulation with Weightain ®.

| Ingredient | Weight % |
|---|---|
| Baby oats | 12.00% |
| Sustagrain ® flakes | 3.00% |
| Sustagrain ® flour | 7.20% |
| Baking Powder | 0.80% |
| White AP flour | 23.25% |
| Lactose | 8.25% |
| Weightain ® | 10.00% |
| Promitor 85L | 8.8% |
| Salt | 0.5% |
| Oil | 10.0% |
| DATEM | 0.5% |
| Water | 15.8% |

TABLE 14
Effect of Weightain ® on RAG:SAG ratio.

| Sample | RAG | SAG | RAG:SAG Ratio |
|---|---|---|---|
| Sample without Weightain ® | 32% | 13% | 2.44 |
| Sample with Weightain ® | 28% | 12% | 2.33 |

In certain embodiments, a binding agent is added to the dough ingredients in an amount between 5-25% of the dough, which binds the dough ingredients to form a more cohesive food matrix. The food matrix may further affect the rate of glucose absorption by helping to maintain a food bolus during the process of digestion, which limits the exposure of carbohydrates to digestive enzymes. In a general, non-limiting example, the binding agent is a soluble corn fiber. Alternatively, the binding agent may be any low glycemic or resistant sugar or syrup, sucromalt, isomaltulose, multifunctional corn syrup or its equivalents, or resistant maltodextrins. A more specific example of one type of binding agent is Promitor®, which is a soluble corn fiber product offered by Tate & Lyle®.

Additional ingredients may also be added to the dough. The additional ingredients may be selected to control taste, texture, visual appeal, or any other number of desired characteristics. For example, the use of flakes instead of flour is more important in snack products such as clusters, because it is more readily recognizable as a whole grain product and connotes healthiness. Similarly, Sustagrain® flakes may be added to improve visual appeal. Examples of other ingredients that may improve the visual appeal are listed with exemplary ranges: nuts (less than or equal to 20 percent), baking powder (less than or equal to 1 percent), puffed brown rice (less than or equal to 10 percent), modified starch (less than or equal to 4 percent), and salt (less than or equal to 2 percent).

Texture can be controlled by ingredient selection and also processing parameters. For example, in one embodiment, incorporating double-acting baking powder was added in the range of (0.5-0.8%) to provide a cracker with a lighter, crispier texture. In another embodiment, high temperature baking (greater than or equal to 275° F.) results in more air pockets, which provides a lighter structure with less hardness. For some crackers, a short burst of heat at 275° provides a rise with acceptable texture. In other embodiments, decreased thickness of the cracker during the forming stage so that the wet cracker is formed from 12.5 grams of dough rather than 15 grams provides acceptable texture. In some embodiments, a crunchy, crispy texture can be achieved by utilizing a unique blend of starches. In particular, UltraCrisp®, XPandR™, and Amylogel® can be combined in a ratio of 2:1:1.

Moisture Content of Dough

Dough for forming a food product in accordance with the novel aspects of this disclosure should have sufficient moisture to allow it to be easily formed, but not an excessive amount of moisture that would negatively affect the RAG:SAG ratio. To this end, inventors have determined that a moisture content of the dough in the range between 10-23 percent, and more specifically a moisture content in an upper part of that range, such as between 17-23 percent provides an acceptable RAG:SAG ratio of the food product with desirable workability. Moisture content less than 10 percent yields a dough that is exceedingly crumbly and unable to be sheeted or formed into a food product and water in excess of 23 percent yields higher RAG:SAG ratio in some embodiments, which may be undesirable. Experimental results varying moisture content of the dough on RAG:SAG ratio of the final food product can be seen in Table 15.

TABLE 15
Effect of Moisture Content on RAG:SAG Ratio.

| | | Dough | | | RAG:SAG |
|---|---|---|---|---|---|
| Ingredients | Heat Treatment | Moisture | RAG | SAG | Ratio |
| 17% oats, | 275° F. → 185° F. | 27% | 33% | 1.4% | 53.31 |
| 17% | (135° C. → 85° C.) | | | | |
| Sustagrain | cycle | | | | |
| 15% oats, | 275° F. → 185° F. | 22% | 31% | 8% | 3.96 |
| 13% | (135° C. → 85° C.) | | | | |
| Sustagrain | cycle | | | | |

Heat Treatment

Cooking temperatures were varied to determine the resultant effect on RAG:SAG ratio. Lower cooking temperatures resulted in lower RAG:SAG ratios, as can be seen in Table 16. Higher cooking temperatures resulted in higher RAG:SAG ratios, and temperature cycling between high and low temperatures yielded intermediate values.

TABLE 16
Effect of Heat Treatment on RAG:SAG Ratio.

| | | | | RAG:SAG |
|---|---|---|---|---|
| Ingredients | Heat Treatment | RAG | SAG | Ratio |
| 17% oats, 17% | 185° F. (85° C.) bake | 33% | 3% | 11.06 |
| Sustagrain, 27% | | | | |
| moisture | | | | |
| 17% oats, 17% | 275° F. → 185° F. | 37% | 1.4% | 53.31 |
| Sustagrain, 27% | (135° C. → 85°) | | | |
| moisture | cycle | | | |
| 17% oats, 17% | 275° F. (135° C.) bake | 43% | 1.7% | 76.15 |
| Sustagrain, 27% | | | | |
| moisture | | | | |

The effect of moisture content and heat treatment on the RAG:SAG ratio of various samples were plotted as a function of moisture content and baking temperature. The results are shown in FIG. 3. Generally, higher moisture content and higher cooking temperatures correlated with higher RAG:SAG ratios.

Using response surface methodology (RSM), inventors have determined that dough moisture content was the most influential factor impacting glucose release, followed by baking temperature, then disaccharide content. More specifically, desirable results as determined by RAG:SAG ratios were achieved when snack samples were created with dough moisture content between 10-22%, and more specifically between 17-22 percent. In some embodiments, based upon the type of snack product to be created, heat treatment with short 5 minute bursts at 275 degrees Fahrenheit interspersed with lower temperature baking at 175 degrees Fahrenheit were found to yield the most desirable Englyst results. A disaccharide content of 8.25-17 percent showed a protective effect at higher temperatures. The combination of moisture control, raw starch with relatively higher levels of SAG, a starch gelatinization inhibitor in the form of a disaccharide, and a binding agent resulted in the creation of a snack product having acceptable organoleptic properties and SAG levels of 10-15 g/100 g and a RAG:SAG ratio in the range of less than 4.2 and more particularly 3.8 or less in some embodiments, or 2.8 or less in other embodiments.

Thus, in accordance with one embodiment, a dough is provided for use in creating a food product having a RAG:SAG ratio of less than 4.2, and in some embodiments less than 3.8, inclusive. In some embodiments, the food product has a RAG:SAG ratio less than 2.8, inclusive, or between 1.9-2.6. The dough is formed from a source of native SAG. The source may include raw whole grain flour, which typically has RAG and SAG in equal concentrations, or All-Purpose flour. The dough should also comprise a viscosity-building ingredient, a starch gelatinization inhibitor, and a binding agent, as previously discussed.

In one embodiment where the dough-based food is a cracker, the dough described above may be used to form the cracker snack that has a RAG:SAG ratio of less than 4.2, and more particularly 3.8 or less, or in the range of 1.9-2.6, inclusive. Further, the cracker should have a final moisture content of between 3.0 and 4.0 percent, but more particularly about 3.5 percent to provide the desired crunchiness. The dough-based food product should have a final moisture content that is between 35-15% less than its intermediate moisture content. The intermediate moisture content of the dough-based snack is the moisture content of the dough.

In another embodiment, where the dough-based food is a cluster, the dough described above may be used to form the cluster that has a RAG:SAG ratio of less than 4.2, and more particularly less than 3.0, or even more particularly in the range between 2.5 and 3.0. To provide the requisite organoleptic properties, the cluster should have a final moisture content of between 2.0% and 3.0%, and in one particular embodiment a moisture content of about 2.45%. The dough-based food product should have a final moisture content that is between 35-15% less than its intermediate moisture content.

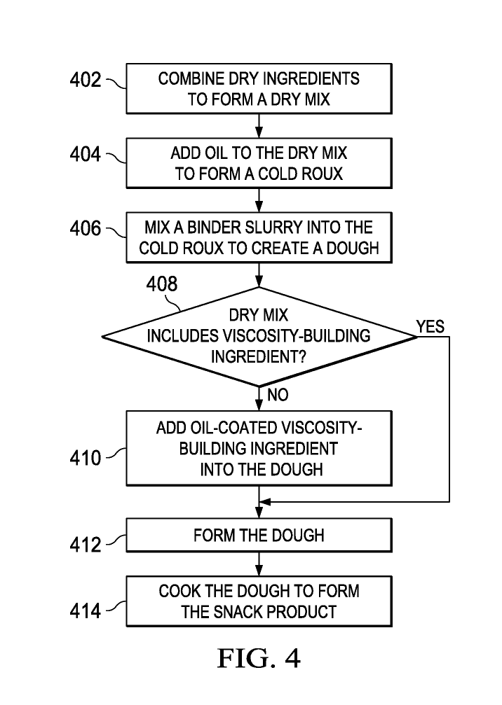

Thus, the RAG:SAG ratio of a dough-based food product is affected by the selection of ingredients, the moisture content of the dough (also referred to as the intermediate moisture content of the dough-based food product), and processing steps, such as cooking duration and temperature. Accordingly, inventors have devised a method as described with reference to FIG. 4 to form a dough-based snack taking into consideration the novel aspects discussed above.

FIG. 4 is a flowchart of a method for producing a dough-based food product having a RAG:SAG ratio less than 4.2 and a final moisture content of between 2.0 and 4.0 in accordance with an illustrative embodiment. Dry ingredients are combined to form a dry mix (step 402). The actual composition of the dry ingredients may vary depending upon a particular product that is being created. For example, if clusters are being made, then the dry ingredients may include the dry ingredients identified in Tables 17 and 18. In contrast, if a cracker product is being made, then the dry ingredients may include the dry ingredients identified in Table 19 and 20. Moreover, in certain embodiments, one or more dry-mix ingredients may be withheld during this step and added at a later step in the process.

Oil is added to the dry mix to form a cold roux (step 404). Non-limiting examples of oil may include commonly available cooking oils such as sunflower oil, canola oil, corn oil, olive oil, and vegetable oil. Importantly, oil should be added to the dry mix before added water is introduced to form the dough. The addition of oil prior to added water allows a protective coat of oil to form on the starch-based ingredients, which reduces the exposure to water and enzymes. As a result, the rate of starch digestion is reduced.

A binder slurry is then mixed into the cold roux to form a dough (step 406). The binder slurry is formed from a mixture of water and a soluble fiber. Sufficient water is added with the binder slurry to raise the moisture content of the dough to a range between 10-23% moisture, particularly between 17-23% moisture. Thus, in an exemplary embodiment, the added water in the binder slurry is between 5-15% of the batch weight of the dough and the soluble fiber is between 5-25% of the batch weight of the dough. In a more specific but non-limiting embodiment, water is mixed with soluble fiber with each forming about 10% of the batch weight of the dough.

A determination is made as to whether the dry mix included a viscosity-building ingredient (step 408). The viscosity-building ingredient may include Weightain®, Sustagrain®, oat flakes and barley flakes, or any starch gum or hydrocolloid that imparts viscosity. Sufficient amounts of the viscosity-building ingredient should be added so that it forms between 10-20% of the batch weight of the dough. If the dry mix does not include the viscosity-building ingredient, then the oil-coated viscosity-building ingredient is mixed into the dough (step 410). Then the dough is formed (step 412). In a first embodiment, the dough is formed into a cracker. In this embodiment, the dough is sheeted then cut into a shape to form a cracker. In another embodiment, the dough is pressed into one or more molds to form a cluster or biscuit. However, the dough may be formed into any number of different shapes depending upon a number of factors such as customer preferences, packaging considerations, products to which the dough-based snack may be added.

Thereafter, the formed dough is cooked to form the snack product (step 414). The snack product is cooked until it achieves a final moisture content between 2.0% and 4.0%. Moisture contents of crackers are typically in the range of 3.0-4.0%, and in one particular embodiment, approximately 3.5%. Moisture contents of clusters are typically in the range between 2.0-3.0%, and in one particular embodiment 2.45%. Depending upon the type of snack product being produced, the cooking step may vary. For example, to achieve an overall crunchiness of the cluster snacks, the dough can be cooked at a relatively high temperature of about 250 degrees Fahrenheit for 45 minutes. In contrast, the cracker snacks achieve their surface toastiness with a heat treatment step that cycles between a high cooking temperature of 275 degrees Fahrenheit for about five minutes followed by low temperature baking at 185 degrees Fahrenheit for an extended period of time, such as 150 minutes. In an alternate embodiment, the actual ranges of 185-275 may be substituted for a first temperature and a second temperature that have a difference of about 90 degrees Fahrenheit. In yet another embodiment, the cracker may be baked at a temperature of 275° F. for about 20-25 minutes to achieve a final moisture content of about 3.5%.

Returning to step 408, if the determination is made that the dry mix ingredients does include a viscosity-building ingredient, then the process skips ahead to step 412 where the dough is formed.

### Cracker Examples

Table 17 provides a non-limiting example of ingredients usable to formulate a cracker snack product in accordance with the novel aspects discussed above. When prepared in accordance with the method of FIG. 4 the RAG:SAG ratio of the cracker created with the ingredients in Table 17 is 2.33.

TABLE 17
Exemplary Cracker Formulation.

| Ingredient | Weight % | Moisture (g/100 g) |
|---|---|---|
| Baby oats | 10.57 | 9.00 |
| Sustagrain ® flakes | 5.61 | 11.50 |
| Sustagrain ® flour | 2.40 | 11.50 |
| Butter Flavor | 0.08 | 0.00 |
| Baking Powder | 0.80 | 3.00 |
| Weightain ® | 10.00 | 10.57 |
| White AP flour | 21.62 | 13.40 |
| Lactose | 17.00 | 0.00 |
| Soluble Fiber | 15.0 | 28.00 |
| Salt | 0.5 | 0.20 |
| Oil | 7.9 | 0.00 |
| DATEM | 0.5 | 0.00 |
| Water | 8.0 | 100.00 |
| TOTALS | 100.00 | 18.05 |

DATEM refers to diacetyl tartaric acid ester of mono- and diglycerides, and is a common emulsifier, which was implemented to soften the dough.

In another non-limiting example, an active cracker was formulated for a clinical trial to confirm blood glucose and insulin responses in vivo. The particular formulation is shown in Table 18 below.

TABLE 18
Active Cracker Formulation for Clinical Trial.

| Ingredient | Weight % |
|---|---|
| Baby oats | 8.04 |
| Sustagrain ® flakes | 4.40 |
| Sustagrain ® flour | 1.76 |
| NAT FL (Molten | 0.08 |
| Butter Type) | |
| Baking Powder | 0.80 |
| Weightain ® | 10.00 |
| White AP flour | 30.00 |
| Sugar | 17.00 |
| Promitor ® 85L | 15.00 |
| Salt | 0.50 |
| Oil | 7.92 |
| DATEM | 0.50 |
| Water | 4.00 |

The process described in FIG. 4 was used to create the active cracker in Table 18. Specifically, the dry ingredients mixed in step 402 excluded the viscosity-building ingredient, which is added in a later step after the dough has been formed. In this example, the resultant dry mix is mixed for 30-60 seconds with a stand mixer in step 402. Half the amount of oil is added to the dry mix and mixed for an additional 30-60 seconds to form the cold roux of step 404. A binder slurry formed from sucrose, water, and Promitor® is added to the cold roux and mixed for an additional 30-60 seconds to form the dough of step 406. The binder slurry is formed by dissolving sucrose and Promitor® into water heated to 60° C.

After the dough is formed, the oil-coated viscosity-building ingredient is added to the dough and mixed for an additional 30-60 seconds, as described in step 416. The process continues to step 410, where the dough is formed. In this example, the dough is formed by weighing out 12.5 grams of dough, which is pressed into a uniform thickness using a #13 mold and stamp set. The molded snack is transferred to a baking tray for the subsequent cooking of step 412. Specifically, the dough is baked at 275° F. for 23 minutes to achieve a final moisture content of 3.5%.

### Cluster Examples

Novel aspects disclosed above could also be applied to the creation of a food product in the form of a cluster. One example of a cluster formulation is shown in Table 19.

TABLE 19
Hybrid Cluster Formulation.

| Ingredient | Weight % | Moisture (g/100 g) |
|---|---|---|
| Grade A Oats | 11.9 | 9 |
| Barley Flakes | 14.0 | 10.5 |
| Flour (All Purpose) | 25.00 | 11.92 |
| Almonds | 15.0 | 3 |
| Baking Powder | 0.5 | 3 |
| Puffed Brown Rice | 6.1 | 3 |
| Vegetable Oil | 4.5 | 0 |
| Soluble Fiber | 10.0 | 28 |
| Modified Starch | 2.0 | 11.85 |
| Salt | 0.9 | 0.2 |
| Water | 10.0 | 100 |
| TOTALS | 100 | 19.21% |

In another example, an active cluster was formulated for use in a clinical trial and included the ingredients listed in Table 20.

TABLE 20
Active Cluster Formulation for Clinical Trial

| | | Moisture |
|---|---|---|
| Ingredient | Weight % | (g/100 g) |
| Old Fashioned Oats | 13.9 | 9 |
| Whole Grain Barley | 14.0 | 10.5 |
| Flakes | | |
| Flour (All Purpose) | 25.00 | 11.92 |
| Almonds | 15.0 | 3 |
| Baking Powder | 0.5 | 3 |
| Puffed Brown Rice | 6.1 | 3 |
| Butter Flavor | 0.2 | 1 |
| Canola Oil | 4.5 | 0 |
| Soluble Corn Fiber | 10.0 | 28 |
| Salt | 0.9 | 0.2 |
| Water | 10.0 | 100 |
| TOTALS | 100 | 19.21% |

To create the active cluster shown in Table 20, all dry ingredients were first combined and mixed. Oil was then added to form the cold roux. Thereafter the binder slurry, which included water and Promitor® were mixed in to form the dough. After forming into clusters, the clusters were baked in an oven at 250° F. for 45 minutes. The resultant RAG:SAG ratio of the active cluster was 2.81.

In addition to the hybrid cluster and the active cluster described in Tables 19 and 20 above, other cluster formulations are described in Table 21, below. Notably, the addition of Sustagrain® flakes lowered the RAG, and inclusion of Weightain reduced the RAG:SAG ratio further.

TABLE 21
Various Cluster Formulations with Corresponding RAG:SAG Ratio.

| | | | | RAG:SAG |
|---|---|---|---|---|
| Ingredients | Heat Treatment | RAG | SAG | Ratio |
| 40% oats, no Sustagrain flakes, 20% | 250° F. bake | 28% | 7% | 3.84 |
| almonds, 5% puffed rice, 29% Promitor | | | | |
| 19% oats, 19% Sustagrain flakes, 20% | 250° F. bake | 25% | 6% | 3.96 |
| almonds, 6.5% puffed rice, 29% | | | | |
| Promitor | | | | |
| 10% Weightain, 16% oats, 17% | 250° F. bake | 23% | 6% | 3.66 |
| Sustagrain flakes, 17% almonds, 6% | | | | |
| puffed rice, 27% Promitor, | | | | |
| 26% moisture content dough coated with | 250° F. bake | 33% | 4% | 7.54 |
| 19% oats, 19% Sustagrain flakes, 20% | | | | |
| almonds, 6.5% puffed rice, 29% | | | | |
| Promitor | | | | |

Clinical Trials

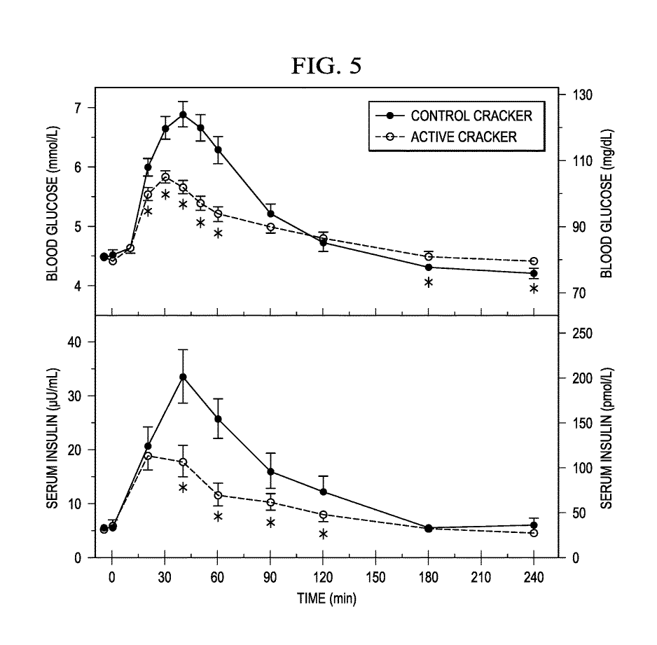

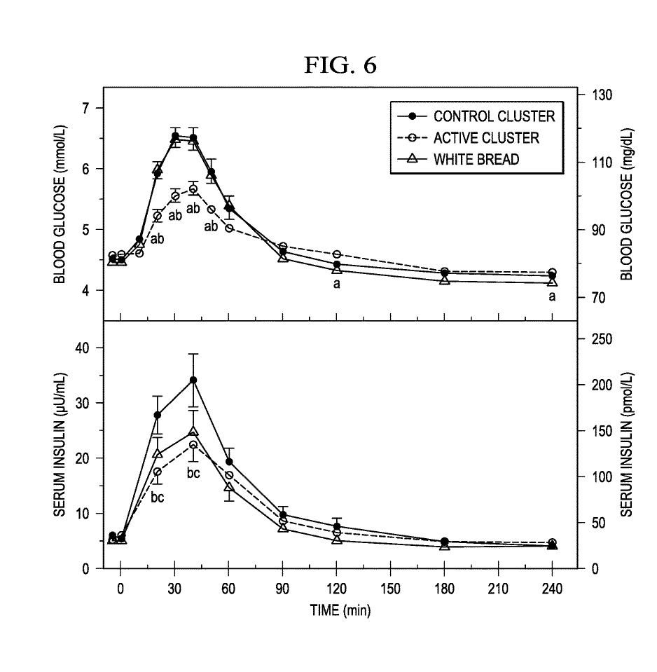

Inventors sought to confirm the results of Englyst tests for the dough-based food products in two separate clinical trials. In the first clinical trial, an active cracker was tested against a control cracker. In the second clinical trial, an active cluster was tested against a control cluster. Test subjects were provided with test meals, which consisted of either the active cracker or control cracker in the first clinical test, or an active cluster, control cluster, or white bread in the second clinical test. Blood glucose and serum insulin concentrations were taken at various times over a 4-hour period for each test meal and plotted. The purpose of taking both blood glucose and serum insulin measurements was to ensure that there was no disproportionate increase in insulin compared to the glucose response. Results, which are discussed in more detail in FIGS. 5 and 6 below, show that the active cracker and active cluster have desirable glycemic responses when compared to their counterpart controls.

FIG. 5 is a graph depicting in vivo blood glucose and serum insulin responses for the cracker trial. Twenty-five healthy adults participated in the clinical trial, which was designed as a randomized, single-blind, crossover trial. On each test occasion, fasting blood samples for glucose analysis were obtained before the subject consumed a test meal, which consisted of either the active cracker or the control cracker. At the first bite a timer was started and additional blood samples for glucose analysis were taken at 10, 20, 30, 40, 50, 60, 90, 120, 180 and 240 minutes. Additional blood samples were taken −5, 0, 20, 40, 60, 90, 120, 180 and 240 minutes for insulin analysis.

In creating the control cracker, all protective factors identified above were removed. Thus, a higher level of all-purpose flour was used, which included relatively higher moisture content. Disaccharides were omitted, which have a protective effect against starch gelatinization. Similarly, Weightain® and Promitor were also excluded. Furthermore, a dough resting step was included, which promoted starch granule hydration. Finally, the baking temperature was selected to provide an acceptable texture but without regard to effect on gelatinization. Ingredients of the control cracker are shown in Table 22, below.

TABLE 22
Ingredients for Control Cracker.

| Ingredient | Weight % |
|---|---|
| Baby Oats | 7.80 |
| Baking Powder | 0.43 |
| Modified Starch (X- | 1.66 |
| PandR) | |
| Modified Starch | 3.30 |
| (UltraCrisp) | |
| NAT FL (Molten | 0.07 |
| Butter Type) | |
| AP Bleached Flour | 52.20 |
| Salt | 0.71 |
| Oil | 6.15 |
| Mono & | 0.19 |
| Diglycerides | |
| Water | 27.47 |

To create the control cracker, all dry phase ingredients were thoroughly mixed. In one embodiment, mixing was accomplished with a stand mixer for 30-60 seconds. Oil was mixed into the dry ingredients and mixed further, for about 30-60 seconds. Water was added and then mixed for an additional 30-60 seconds. A predetermined amount of the resultant dough was weighed and pressed into a uniform thickness and baked at 300° F. for 43 minutes until the moisture content was reduced to 3.5%. An Englyst test was performed comparing the active cracker with the control cracker, the results of which are depicted in Table 23, below.

TABLE 23
Nutrient Content and Englyst Results Comparing Control and
Active Crackers.

| | | | | | | | | | Englyst | |
|---|---|---|---|---|---|---|---|---|---|---|
| | Weight | Energy | Protein | Fat | Carbohydrate (g) | | | | Results (avg) | |
| Test Meal | (g) | (Kcal) | (g) | (g) | Total | Fiber | Sugar | Avail. | RAG | SAG |
| Control | 56 | 245 | 5.3 | 6.5 | 34 | 1.7 | 0.1 | 39.0 | 66.6 | 0.30 |
| Cracker | | | | | | | | | | |
| Active | 56 | 217 | 3.9 | 6.6 | 35 | 11.6 | 11.1 | 30.8 | 36.70 | 9.90 |
| Cracker | | | | | | | | | | |

Englyst results in Table 23 are the average of three separate samples. Calculating the RAG:SAG ratio for each sample, then averaging the resulting RAG:SAG ratios provides an average RAG:SAG ratio of 139.6 for the control cracker, and a RAG:SAG ratio of 3.8 for the active cracker.

With respect to the blood glucose and insulin response curves of FIG. 5, it is evident that blood glucose concentration after consumption of the active cracker was significantly less than that after consumption of the control cracker at 20 minutes (p=0.0026), 30 minutes (p=0.00005), 40 minutes (p<0.00001), 50 minutes (p<0.00001) and 60 minutes (p<0.00001), and significantly higher than that after control at 180 (p=0.031) and 240 (p=0.0065) minutes. Serum insulin concentration after consumption of the active cracker was significantly less than after consumption of the control cracker at 40 minutes (p=0.00016), 60 minutes (p=0.0014), 90 minutes (p=0.047) and 120 minutes (p=0.0496). Significant differences between the control and active crackers are identified with an asterisk.

It was hypothesized that the active cracker would elicit lower glucose and insulin responses than the control because it would be more slowly digested. However, the portion tested contained 21% less available carbohydrate (avCHO) than the control (30.8 g versus 39 g), which would also reduce its glycemic and insulinemic impact. The contribution of the reduced avCHO intake to the reduced glycemic response can be estimated, but this is not a simple proportional relationship because the dose-response curve of 0-2 hour area under the curve (AUC) on dose of avCHO consumed is not linear, as shown in several studies (Wolever and Bolognesi, 1996, Lee and Wolever, 1998; Wolever et al. 2006). In addition, the 0-2 hour AUC is proportional to the food GI; thus the 0-2 hour AUC elicited by a food, relative to that elicited by 50 g glucose (RGR) can be estimated from the following equation:

RGR=1.49×GI×(1−e^{-0.0222g})

where g is the grams avCHO consumed and GI is the food glycemic index (Wolever, 2006). Accordingly, the RGR for 39 g glucose (GI=100) is 86.3 and that for 30.8 g is 73.8; thus, 30.8 g avCHO would be expected to elicit a glycemic response 100×73.8/86.3=85.5% than that of 39 g avCHO (14.5% reduction). The results showed that the mean glycemic response (0-2 hour AUC) elicited by the active cracker was 100*84.9/146.4=58% of that of the control (42% reduction). Since the reduction in avCHO intake only accounts for about 34% of the reduction in glycemic response, the results support the hypothesis that the avCHO in the active cracker are more slowly digested in-vivo than those in the control. This is also suggested by the fact that glycemic response curve after the active cracker was flatter than that after the control with a lower peak but a slower fall of blood glucose, with significantly higher blood glucose concentration than the control 3 and 4 hours after consumption. The slower fall in blood glucose could also be due, at least in part, to the reduced insulin response elicited by the active cracker. The results demonstrate that the reduction in the insulin response elicited by the active cracker, compared to control was proportional to the reduction in glucose response.

A clinical trial for the cluster food product was conducted similarly to the cracker, except that a white bread test meal was also considered. The results are shown in FIG. 6, which is a graph depicting in vivo blood glucose and serum insulin responses for the cluster trial.

The active cluster, control cluster, and white bread test meals were provided to twenty-five healthy adults on three separate days over a period of 2-4 weeks. On each test occasion, after subjects were weighed, two fasting blood samples for glucose analysis were obtained by finger prick 5 minutes apart and after the second sample, the subject started to consume a test meal. Subjects were asked to consume the entire test meal within 10 minutes. At the first bite a timer was started and additional blood samples for glucose analysis were taken at 10, 20, 30, 40, 50, 60, 90, 120, 180 and 240 minutes after starting to eat. An additional 6-8 drops of blood was taken into a separate vial at −5, 0, 20, 40, 60, 90, 120, 180 and 240 minutes for insulin analysis.

The control cluster was created using the formulation listed in Table 24, below.

TABLE 24
Ingredients for Control Cluster.

| Ingredient | Weight % |
|---|---|
| Quick Oats | 39.0 |
| Peanuts | 10.0 |
| Puffed Brown Rice | 9.0 |
| Modified Starch | 1.0 |
| Butter Flavor | 0.2 |
| Canola Oil | 5.6 |
| Corn Syrup | 31.0 |
| Salt | 0.9 |
| Water | 3.5 |

To create the control clusters, all dry ingredients were combined and mixed for about 30 seconds. A slurry was prepared, added to the dry ingredients, and mixed for 60 seconds. The slurry included the corn syrup, water, and oil. The resultant dough was formed into clusters and baked at 325° F. for 25 minutes.

An Englyst test was performed comparing the active cluster with the Control cluster and white bread, the results of which are depicted in Table 25.

TABLE 25
Nutrient Content and Englyst Results Comparing active cluster,
control cluster, and white bread.

| | | | | | | | | | Englyst | |
|---|---|---|---|---|---|---|---|---|---|---|
| | Weight | Energy | Protein | Fat | Carbohydrate (g) | | | | Results | |
| Test Meal | (g) | (Kcal) | (g) | (g) | Total | Fiber | Sugar | Avail. | RAG | SAG |
| Active | 56 | 224 | 5 | 12 | 34 | 10 | 1 | 24 | 16.3 | 6.7 |
| Cluster | | | | | | | | | | |
| Control | 56 | 250 | 5 | 11 | 35 | 2 | 13 | 33 | 30.2 | 2.8 |
| Cluster | | | | | | | | | | |
| White | 47 | 120 | 4 | 0.5 | 25 | 1 | 0 | 24 | 22.6 | 1.4 |
| Bread | | | | | | | | | | |

Blood glucose and insulin response curves for the cluster trial are depicted in FIG. 6. The results indicate that there was no significant effect of order on blood glucose or insulin concentration at any time point. Blood glucose concentration after the active cluster was significantly less than those after both white bread and the control cluster at 20, 30, 40 and 50 minutes, and significantly higher than that after white bread at 120 and 240 minutes. Serum insulin concentrations after the active cluster and white bread were significantly less than that after the control cluster at 20 and 40 minutes. With reference to FIG. 6, points identified by the letter “a” indicate a significant difference between the active cluster and white bread, points identified by the letter “b” indicate a significant difference between the active cluster and the control cluster, and points identified by the letter “c” indicate a significant difference between the control cluster and white bread.

It was hypothesized that the active cluster would elicit lower glucose and insulin responses than the control because it would be more slowly digested. However, the portion tested contained 27% less available carbohydrate (avCHO) than the control (24 g vs 33 g) which would also reduce its glycemic and insulinemic impact. The contribution of the reduced avCHO intake to the reduced glycemic response can be estimated as discussed above. Accordingly, the RGR for 33 g glucose (GI=100) is 77.4 and that for 24 g is 61.5; thus, 24 g avCHO would be expected to elicit a glycemic response 100×61.5/77.4=79.5% that elicited by 33 g avCHO (20.5% reduction). The results showed that the mean glycemic response (0-2 hr AUC) elicited by the active cluster was 100*62/112=55% of that of the control (45% reduction). Since the reduction in avCHO intake only accounts for about 46% of the reduction in glycemic response, the results support the hypothesis that the avCHO in the active cluster are more slowly digested in-vivo than those in the control. This is also suggested by the fact that glycemic response curve after the active cluster was flatter than that after white bread with a lower peak but a slower fall of blood glucose, with significantly higher blood glucose concentration than white bread 2 and 4 hours after consumption. However, the slower fall in blood glucose could also be due, at least in part, to the higher amount of fat in the active clusters; 12 g versus 0.5 g in white bread.

The possible effect on the blood glucose 0-2 hour AUC of adding fat to a solid food can be estimated from a study in which we determined the effect on the glycemic response of adding 0, 5, 10, 20 and 40 g fat as margarine to a 50 g available carbohydrate (avCHO) portion of white bread (Owen and Wolever, 2003). The dose-response effect of fat on the 0-2 hour AUC tended to decay in non-linear fashion as follows:

AUC=(47×e^{-0.0522×g})+119

The equation is for grams fat per 50 g avCHO; to apply it here the amount of fat per 50 g avCHO in the active and control clusters has to be calculated, which is 25 g and 17 g, respectively. It these values are inserted into the previous equation for “g” they result in estimated AUCs of 132 and 138, respectively, or 79% and 83%, respectively, of the AUC for 0 g fat. The active cluster elicited a 0-2 hour AUC which was 55% of that for white bread (45% reduction); dividing this by the estimated effect of fat (0.79) yields a value of 70%, which represents the glycemic impact of the carbohydrates in the active cluster, relative to white bread, corrected for their fat content—i.e. a 30% reduction. Thus it is estimated that approximately ⅓ of the 45% lower glycemic impact of the active cluster, relative to white bread, is due to the fat it contains and ⅔ to the more slowly absorbed carbohydrates.

The results show that the 0-2 hour AUC for insulin after the active cluster was 31% less than that for the control, which value is not significantly different from the 42% reduction in glucose response. However, the control cluster elicited a 47% higher insulin response compared to white bread in the face of virtually identical glycemic responses; in addition the insulin response elicited by active cluster was similar to that after white bread in the face of a significantly lower glycemic response. Thus, both clusters elicited disproportionately increased insulin responses when compared to white bread. The clusters contained a similar amount of protein as white bread but much more fat. The addition of fat to a starchy food stimulates GIP secretion which, in turn, potentiates the ability of a rise in blood glucose to stimulate insulin secretion (Collier et al. 1988). When Collier et al. (1984) added 37.5 g fat to 75 g carbohydrate from potato it elicited a 0-2 hour glucose AUC which was 42% of that for the potato alone, but an insulin AUC which was 84% of that after potato alone.

Thus, adding 0.5 grams of fat per gram of carbohydrate resulted in a relative insulin response (84%) which was disproportionately increased when compared to the relative glucose response (42%)—the relative insulin response was double the relative glucose response. In this clinical trial, the control cluster contained relatively less fat (0.33 grams per gram of carbohydrate) and the relative insulin response was increased relatively less (by about 50%). The presence of fat also likely explains why the active cluster elicited a disproportionately higher insulin response, relative to white bread, than its glucose response. However, when insulinemic response of the active cluster is compared to that of the control cluster, it is not disproportionately increased, since both clusters contain similar amounts of fat.

The active and control clusters were analyzed to determine whether their respective characteristics could help explain the glycemic response observed in the clinical trials. The results of these tests are shown in Tables 26 and 27 below.

TABLE 26
Comparison of active and control cluster characteristics.

| | | | | | | | Glass Transition | | |
|---|---|---|---|---|---|---|---|---|---|
| | | Texture - | | | | | Temperature (° C.) | | |
| | Moisture | Hardness | Viscosity (RVU) | | | Density | As is | 10% | 16% |
| Sample | (wt %) | (gram) | Peak | Trough | Final | (g/cm³) | Moisture | Moisture | Moisture |
| Control | 1.18 | 39986.6 ± 7551.4 | 10.58 | 10.33 | 26.58 | 1.2837 ± 0.002 | 183 | 74.4 | 50.6 |
| Cluster | | | | | | | | | |
| Active | 2.45 | 30999.4 ± 6468.2 | 31.67 | 27.25 | 82.83 | 1.2941 ± 0.002 | 107.7 | 79.4 | 55.9 |
| Cluster | | | | | | | | | |

TABLE 27
Comparison of fiber content in cluster trial.

Dietary Fiber

| | Insoluble Dietary | Soluble Dietary |
|---|---|---|
| Sample | Fiber (%) | Fiber (%) |
| Control Cluster | 5.05 | 4.76 |
| Active Cluster | 9.20 | 12.90 |

With reference to Table 26, the control cluster has a higher hardness, which requires more force to break. The control cluster also has a lower peak viscosity, 10.58 RVU, which equates to a viscosity of about 126 centipoise. In contrast, the active cluster product has a high peak viscosity of about 380 centipoise. Lower peak viscosities are indicative of more fully cooked products, which corresponds with greater starch gelatinization. Greater starch gelatinization promotes accessibility by enzymes, resulting in increased rate of glucose release and uptake. Such a result increases RAG concentration, which also increases the RAG:SAG ratio. A comparison of the glass transition temperatures of the control cluster and the active cluster shows that the control cluster has more moisture. Because starch gelatinizes in the presence of heat and moisture, more moisture results in higher rates of starch gelatinization, which increases RAG and also the RAG:SAG ratio.

With reference to Table 27, the active cluster is shown to have a higher concentration of dietary fiber than the control, which is believed to be correlated with slower gastric emptying and a more desirable glycemic response.

Porosity of the control cluster and the active cluster were also measured using low intensity x-rays. The active cluster had a porosity of approximately 36% whereas the control cluster had a porosity of approximately 54%. Greater porosity, as seen in the control cluster, provides more void spaces in the cluster product, which would enable easier enzyme penetration as compared to a cluster with less porosity. Greater enzyme penetration would result in a higher rate of starch gelatinization, which increases RAG and also the RAG:SAG ratio.

The results of the clinical trials support the conclusion that novel aspects of the disclosure relating to ingredient selection, dough moisture content, and processing parameters, are capable of creating dough-based snacks with desirable RAG:SAG ratios that have positive Englyst results and which correlate with desirable glucose and insulin responses.

Although the particular examples provided above relate primarily to savory, dough-based, crunchy snack products such as clusters and crackers, the novel aspects of the disclosure may be applied to other categories of food or beverage, including but not limited to granola products including muesli, granola bars, and granola cereals; extruded cereals, flaked cereals, baked bars, hot cereals, cookies, biscuits, grain-containing beverages, grain-containing powders, sheeted and baked ready-to-eat (RTE) cereals, powdered beverages and milk modifiers, pasta and noodles, and ready-to-drink (RTD) refrigerated and frozen beverages. Thus, in one embodiment, inventors disclose a food or beverage product with a RAG:SAG ratio of between 1.5-4.2 and an intermediate form that has a moisture content greater than 10 percent, or alternatively greater than 17 percent. The food or beverage product may also have a final moisture content between 2.0-20 percent, or higher.

Further, depending upon the type or category of food or beverage product, processing conditions may be changed and ingredients may be altered and/or apportioned in varying amounts. For example, certain categories of snacks may have final moisture contents that exceed 2.0 percent and found in the range of 2.0-20 percent. Further, the corresponding dough moisture contents may also be higher, having a range between 17-23 percent moisture, or in other embodiments, moisture contents that exceed 23 percent. Likewise, the associated RAG:SAG ratios may have values that overlap the range of RAG:SAG ratios described above, or may have RAG:SAG ratios in excess of 4.2 depending upon the ingredients and processing steps.

The cooking steps described herein may also vary depending upon the type or category of snack product. For example, snacks that do not require a crunchy profile may be cooked at a lower temperature or shorter time period.

Any solution that purports to offer an improved glycemic response that only focuses on one mode of action, such as prevention of starch gelatinization is an incomplete solution because of the various factors that affect glucose absorption. Unlike other prior art solutions, the solution disclosed herein is comprehensive and provides for multiple modes of action for creating a dough and a dough-based snack with a RAG:SAG ratio that is believed to provide a beneficial glycemic response, but which also produces a dough-based snack with desirable organoleptic properties, such as taste and texture.

Based upon RAG:SAG ratios achieved by the selection and combination of novel ingredients and particular processing steps, and in conjunction with supporting literature, inventors have created a dough-based food product that can provide a desired post-prandial glycemic response characterized by a slow release of energy and improved satiety. Further, ingredients incorporated into the snack product enable the creation of a savory, crunchy snack product that can be formed into one of a number of desirable shapes, including crackers, biscuits, or clusters.

While this invention has been particularly shown and described with reference to certain embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### ADDITIONAL DESCRIPTION

In a first embodiment, the disclosure describes a dough for creating a snack product having a rapidly available glucose and slowly available glucose (RAG:SAG) ratio of less than 4.2. The dough comprises a source of rapidly available glucose (RAG) and slowly available glucose (SAG), a viscosity-building ingredient coated with oil, a starch gelatinization inhibitor, and a binding agent that binds ingredients of the dough to form a food matrix. The dough comprises a moisture content between 10-23%.

In another embodiment including any one or more of the elements in a previous embodiment disclosed above, the viscosity-building ingredient comprises one or more of barley flakes, oat flakes, and a digestible dietary fiber ingredient consisting of whole grain corn flour, a non-digestible dietary fiber, beta glucan, and guar gum; and the viscosity-building ingredient comprises between 10-20% of a batch weight of the dough.

In another embodiment including any one or more of the elements in a previous embodiment disclosed above, the starch gelatinization inhibitor comprises one or more of sucrose and lactose, and the starch gelatinization inhibitor comprises between 10-25% of a batch weight of the dough.

In another embodiment including any one or more of the elements in a previous embodiment disclosed above, the binding agent comprises one or more of a low glycemic or resistant sugar or syrup, sucromalt, isomaltulose, multifunctional corn syrup, resistant maltodextrins, and soluble corn fiber; and the binding agent comprises between 5-25% of a batch weight of the dough.

In another embodiment including any one or more of the elements in a previous embodiment disclosed above, the source of RAG and SAG comprises one or more of raw whole grain flour, white flour, and all-purpose flour; and the source of RAG and SAG comprises between 5-35% of a batch weight of the dough.

In another embodiment including any one or more of the elements in a previous embodiment disclosed above, the dough further comprises at least one of nuts, baking powder, puffed brown rice, modified starch, and salt; and the baking powder comprises less than 1% of a batch weight of the dough, the nuts comprise less than 20% of the batch weight, the puffed brown rice comprises less than 10% of the batch weight, the modified starch comprises less than 4% of the batch weight, and the salt comprises less than 2% of the batch weight.

In another embodiment including any one or more of the elements in a previous embodiment disclosed above, the dough further comprises added water between 5-15% of a batch weight of the dough to achieve the moisture content between 10-23%.

In another embodiment, the disclosure describes a dough-based food product comprising a source of rapidly available glucose (RAG) and slowly available glucose (SAG), a viscosity-building ingredient coated with oil, a starch gelatinization inhibitor, a binding agent that binds ingredients of the dough to form a food matrix. The dough-based snack comprises a RAG:SAG ratio less than 4.2 and a final moisture content of between 2.0-4.0%.

In another embodiment including any one or more of the elements in a previous embodiment disclosed above, the dough-based food product further comprises an intermediate moisture content, and wherein the final moisture content is between 35-15% less than an intermediate moisture content of a dough used to form the dough-based food product.

In another embodiment including any one or more of the elements in a previous embodiment disclosed above, the viscosity-building ingredient comprises one or more of barley flakes, oat flakes; and a digestible dietary fiber ingredient consisting of whole grain corn flour, a non-digestible dietary fiber, beta glucan, and guar gum; and wherein the viscosity-building ingredient comprises between 11-25% of the dough-based food product.

In another embodiment including any one or more of the elements in a previous embodiment disclosed above, the starch gelatinization inhibitor comprises one or more of sucrose and lactose; and wherein the starch gelatinization inhibitor comprises between 11-31% of the dough-based food product.

In another embodiment including any one or more of the elements in a previous embodiment disclosed above, the binding agent comprises one or more of a low glycemic or resistant sugar or syrup, sucromalt, isomaltulose, multifunctional corn syrup, resistant maltodextrins, and soluble corn fiber; and wherein the binding agent comprises between 5-31% of the dough-based food product.

In another embodiment including any one or more of the elements in a previous embodiment disclosed above, the source of RAG and SAG comprises one or more of raw whole grain flour, white flour, and all-purpose flour; and wherein the source of RAG and SAG comprises between 5-43% of the dough-based food product.

In another embodiment including any one or more of the elements in a previous embodiment disclosed above, the dough-based food product further comprising at least one of nuts, baking powder, puffed brown rice, modified starch, and salt; wherein the baking powder comprises less than 1.25% of the dough-based food product, the nuts comprise less than 25% of the dough-based food product, the puffed brown rice comprises less than 12.5% of the dough-based food product, the modified starch comprises less than 5% of the dough-based food product; and the salt comprises less than 2.5% of the dough-based food product.

In another embodiment including any one or more of the elements in a previous embodiment disclosed above, the dough-based food product comprising a hardness of between 24,000-37,000 grams.

In another embodiment, the disclosure describes a method for making a dough-based food product comprising the steps of combining selected dry ingredients to form a dry mix, adding oil to the dry mix to form a cold roux, mixing a binder slurry into the cold roux to form a dough, wherein the dough has a batch weight, and wherein the dough comprises a moisture content between 10-23%, and cooking the dough to form the snack product, wherein the snack product comprises a final moisture content between 2.0-4.0% and a RAG:SAG ratio of less than 4.2.

In another embodiment including any one or more of the elements in a previous embodiment disclosed above, wherein the selected dry ingredients comprise one or more of a source of slowly available glucose (SAG) and rapidly available glucose (RAG), a viscosity-building ingredient, and a starch gelatinization inhibitor.

In another embodiment including any one or more of the elements in a previous embodiment disclosed above, the method further comprising mixing an oil-coated viscosity-building ingredient into the dough responsive to the dry mix lacking a viscosity-building ingredient.

In another embodiment including any one or more of the elements in a previous embodiment disclosed above, further comprising forming the dough before the cooking step.

In another embodiment including any one or more of the elements in a previous embodiment disclosed above, the method further comprising mixing water and a soluble fiber to form the binder slurry, wherein the water comprises about 10% of a batch weight of the dough, and wherein the soluble fiber comprises about 10% of the batch weight of the dough.

In another embodiment including any one or more of the elements in a previous embodiment disclosed above, the method further comprises cooking the dough at a temperature between 185-275 degrees Fahrenheit.

In another embodiment including any one or more of the elements in a previous embodiment disclosed above, wherein the cooking step further comprises at least one of cooking the dough for about 45 minutes; and cycling the temperature between a first temperature and a second temperature, wherein the first temperature is greater than the second temperature, and wherein the difference in temperature is about 90 degrees Fahrenheit.

In another embodiment including any one or more of the elements in a previous embodiment disclosed above, wherein the binder slurry comprises is soluble corn fiber and water, the method further comprising mixing water and the soluble fiber to form the binder slurry, wherein the water comprises about 5-15% of a batch weight of the dough, and wherein the soluble fiber comprises about 5-25% of the batch weight of the dough.

We claim:

1. A dough for creating a snack product having a rapidly available glucose and slowly available glucose (RAG:SAG) ratio of less than 4.2, the dough comprising:
a source of rapidly available glucose (RAG) and slowly available glucose (SAG);
a viscosity-building ingredient coated with oil;
a starch gelatinization inhibitor; and
a binding agent that binds ingredients of the dough to form a food matrix;
wherein the dough comprises a moisture content between 10-23%.

2. The dough of claim 1, wherein the viscosity-building ingredient comprises one or more of barley flakes, oat flakes, and a digestible dietary fiber ingredient consisting of whole grain corn flour, a non-digestible dietary fiber, beta glucan, and guar gum; and
wherein the viscosity-building ingredient comprises between 10-20% of a batch weight of the dough.

3. The dough of claim 1, wherein the starch gelatinization inhibitor comprises one or more of sucrose and lactose; and
wherein the starch gelatinization inhibitor comprises between 10-25% of a batch weight of the dough.

4. The dough of claim 1, wherein the binding agent comprises one or more of a low glycemic or resistant sugar or syrup, sucromalt, isomaltulose, multifunctional corn syrup, resistant maltodextrins, and soluble corn fiber; and
wherein the binding agent comprises between 5-25% of a batch weight of the dough.

5. The dough of claim 1, wherein the source of RAG and SAG comprises one or more of raw whole grain flour, white flour, and all-purpose flour; and
wherein the source of RAG and SAG comprises between 5-35% of a batch weight of the dough.

6. The dough of claim 1, further comprising at least one of nuts, baking powder, puffed brown rice, modified starch, and salt; wherein
the baking powder comprises less than 1% of a batch weight of the dough;
the nuts comprise less than 20% of the batch weight;
the puffed brown rice comprises less than 10% of the batch weight;
the modified starch comprises less than 4% of the batch weight; and
the salt comprises less than 2% of the batch weight.

7. The dough of claim 1, further comprising:
added water between 5-15% of a batch weight of the dough to achieve the moisture content between 10-23%.

8. A dough-based food product comprising:
a source of rapidly available glucose (RAG) and slowly available glucose (SAG);
a viscosity-building ingredient coated with oil;
a starch gelatinization inhibitor;
a binding agent that binds ingredients of the dough to form a food matrix; and
wherein the dough-based snack comprises a RAG:SAG ratio less than 4.2 and a final moisture content of between 2.0-4.0%.

9. The dough-based food product of claim 8, wherein the snack product further comprises an intermediate moisture content, and wherein the final moisture content is between 35-15% less than an intermediate moisture content of a dough used to form the dough-based food product.

10. The dough-based food product of claim 8, wherein the viscosity-building ingredient comprises one or more of barley flakes, oat flakes; and a digestible dietary fiber ingredient consisting of whole grain corn flour, a non-digestible dietary fiber, beta glucan, and guar gum; and
wherein the viscosity-building ingredient comprises between 11-25% of the dough-based food product.

11. The dough-based food product of claim 8, wherein the starch gelatinization inhibitor comprises one or more of sucrose and lactose; and
wherein the starch gelatinization inhibitor comprises between 11-31% of the dough-based food product.

12. The dough-based food product of claim 8, wherein the binding agent comprises one or more of a low glycemic or resistant sugar or syrup, sucromalt, isomaltulose, multifunctional corn syrup, resistant maltodextrins, and soluble corn fiber; and
wherein the binding agent comprises between 5-31% of the dough-based food product.

13. The dough-based food product of claim 8, wherein the source of RAG and SAG comprises one or more of raw whole grain flour, white flour, and all-purpose flour; and
wherein the source of RAG and SAG comprises between 5-43% of the dough-based food product.

14. The dough-based food product of claim 8, further comprising at least one of nuts, baking powder, puffed brown rice, modified starch, and salt; wherein
the baking powder comprises less than 1.25% of the dough-based food product;
the nuts comprise less than 25% of the dough-based food product;
the puffed brown rice comprises less than 12.5% of the dough-based food product;
the modified starch comprises less than 5% of the dough-based food product; and
the salt comprises less than 2.5% of the dough-based food product.

15. The dough-based food product of claim 8, further comprising a hardness of between 24,000-37,000 grams.

16. A method for making a dough-based food product, the process comprising:
combining selected dry ingredients to form a dry mix;
adding oil to the dry mix to form a cold roux;
mixing a binder slurry into the cold roux to form a dough, wherein the dough has a batch weight, and wherein the dough comprises a moisture content between 10-23%;
cooking the dough to form the snack product, wherein the snack product comprises a final moisture content between 2.0-4.0% and a RAG:SAG ratio of less than 4.2.

17. The method of claim 16, wherein the selected dry ingredients comprise one or more of a source of slowly available glucose (SAG) and rapidly available glucose (RAG), a viscosity-building ingredient, and a starch gelatinization inhibitor.

18. The method of claim 16, further comprising:
responsive to the dry mix lacking a viscosity-building ingredient, mixing an oil-coated viscosity-building ingredient into the dough.

19. The method of claim 16, further comprising:
forming the dough before the cooking step.

20. The method of 16, further comprising:
mixing water and a soluble fiber to form the binder slurry, wherein the water comprises about 10% of a batch weight of the dough, and wherein the soluble fiber comprises about 10% of the batch weight of the dough.

21. The method of claim 16, wherein the cooking step further comprises:
cooking the dough at a temperature between 185-275 degrees Fahrenheit.

22. The method of claim 16, wherein the cooking step further comprises at least one of:
cooking the dough for about 45 minutes; and cycling the temperature between a first temperature and a second temperature, wherein the first temperature is greater than the second temperature, and wherein the difference in temperature is about 90 degrees Fahrenheit.

23. The method of claim 16, wherein the binder slurry comprises is soluble corn fiber and water, the method further comprising:
mixing water and the soluble fiber to form the binder slurry, wherein the water comprises about 5-15% of a batch weight of the dough, and wherein the soluble fiber comprises about 5-25% of the batch weight of the dough.
